(19) United States
(12) Patent Application Publication
(10) Pub. No.: US 2026/0256306 A1
(43) Pub. Date: Sep. 3, 2026

(54) ACCESSORY AND DRINKWARE ASSEMBLIES

(71) Applicant: Cool Gear International, LLC, Plymouth, MA (US)

(72) Inventors: John D. Mason, East Bridgewater, MA (US); Cameron S. Filiau, Quincy, MA (US)

(21) Appl. No.: 19/549,867

(22) Filed: Feb. 25, 2026

Related U.S. Application Data
(60) Provisional application No. 63/765,085, filed on Feb. 28, 2025.

(51) Int. Cl. A47G 19/22; A45C 13/00; A45C 13/30

(52) U.S. Cl. CPC A47G 19/2227; A45C 13/001; A45C 2013/306

(57) ABSTRACT

In embodiments, an accessory assembly includes a base and a figure. The base defines a first coupler and the figure defines a second coupler. The base and the figure are removably coupled to one another via the first coupler and the second coupler.

The present application claims the benefit of U.S. Provisional Patent Application No. 63/765,085, filed February 28, 2025, the entirety of which is incorporated by reference herein.

### TECHNICAL FIELD

The present specification generally relates to accessory assemblies which allow a figure to be removably mounted to an article and, more particularly, to drinkware assemblies including a figure removably mounted thereto.

### BACKGROUND

The personalization of various articles enables users to express themselves more fully. Accordingly, a need exists for new means by which individuals may personalize items such as, but not limited to, bags, drinkware, clothing, or other articles.

### SUMMARY

In one embodiment, an accessory assembly includes a base and a figure. The base defines a first coupler and the figure defines a second coupler. The base and the figure are removably coupled to one another via the first coupler and the second coupler.

In another embodiment, a drinkware assembly includes a drinkware and a figure removably attached to the drinkware. The drinkware includes a vessel body defining an interior volume and an opening into the interior volume and a closure coupled to the vessel body and extending over the opening. At least a portion of the closure is actuatable or removable to provide a flow path from the interior volume.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A depicts a perspective view of an accessory assembly including a figure coupled to a base, according to one or more embodiments shown and described herein;

FIG. 1B depicts a cross-sectional side view of the accessory assembly of FIG. 1A, according to one or more embodiments shown and described herein;

FIG. 1C depicts an exploded view of the accessory assembly of FIG. 1B, according to one or more embodiments shown and described herein;

FIG. 1D depicts a top-down view of the base of FIG. 1A-1C in isolation, according to one or more embodiments shown and described herein;

FIG. 2A depicts a base of an accessory assembly having a chain, according to one or more embodiments shown and described herein;

FIG. 2B depicts a sectional view of an accessory assembly including the base of FIG. 2A, according to one or more embodiments shown and described herein;

FIG. 3A depicts cross-sectional view of an accessory assembly including a base having a chain, according to one or more embodiments shown and described herein;

FIG. 3B depicts a side view of the accessory assembly of FIG. 3A, according to one or more embodiments shown and described herein;

FIG. 3C depicts a bottom perspective view of the accessory assembly of FIG. 3B, according to one or more embodiments shown and described herein;

FIG. 4A depicts a cross-sectional side view of an accessory assembly including figure, a base, and a sticker, according to one or more embodiments shown and described herein;

FIG. 4B depicts a cross-sectional side view of the accessory assembly of FIG. 4A with the sticker attached to the base, according to one or more embodiments shown and described herein;

FIG. 5A depicts a top-down view of a base of an accessory assembly in the form of a strap, according to one or more embodiments shown and described herein;

FIG. 5B depicts a cross-sectional side view of the base of FIG. 5A with a figure coupled thereto, according to one or more embodiments shown and described herein;

FIG. 5C schematically depicts the accessory assembly of FIG. 5B coupled to a bag, according to one or more embodiments shown and described herein;

FIG. 6 depicts an accessory assembly wherein the base is a strap coupled to a carabiner, according to one or more embodiments shown and described herein;

FIG. 7A depicts a perspective view of an accessory assembly including a figure removably coupled to a base having a suction cup, according to one or more embodiments shown and described herein;

FIG. 7B depicts a cross-sectional side view of the accessory assembly of FIG. 7A, according to one or more embodiments shown and described herein;

FIG. 8A depicts a perspective view of an accessory assembly including a figure removably coupled to a base having a clip, according to one or more embodiments shown and described herein;

FIG. 8B depicts a side view of the accessory assembly of FIG. 8A, according to one or more embodiments shown and described herein

FIG. 8C depicts a cross-sectional side view of the accessory assembly of FIG. 8B, according to one or more embodiments shown and described herein;

FIG. 9A depicts a perspective view of an accessory assembly including a figure removably coupled to a drinkware, according to one or more embodiments shown and described herein;

FIG. 9B depicts a cross-sectional side view of the accessory assembly of FIG. 9A, according to one or more embodiments shown and described herein

FIG. 9C depicts a closure of the drinkware of FIG. 9A-9B moved to an open configuration, according to one or more embodiments shown and described herein;

FIG. 10A depicts a perspective view of an accessory assembly including a figure removably coupled to a drinkware, according to one or more embodiments shown and described herein;

FIG. 10B depicts a cross-section of the accessory assembly of FIG. 10A, according to one or more embodiments shown and described herein;

FIG. 10C depicts a closure of the drinkware of FIG. 10A-10B in an exploded configuration, according to one or more embodiments shown and described herein;

FIG. 11A depicts a cross-sectional side view of a figure including a female coupler, according to one or more embodiments shown and described herein; and

FIG. 11B depicts coupling of a male coupler with the female coupler of FIG. 11A, according to one or more embodiments shown and described herein.

### DETAILED DESCRIPTION

Referring generally to the figures, various embodiments of an accessory assembly is generally depicted. In particular, embodiments generally include a base which defines a first coupler and a figure which defines a second coupler. The figure and the base may be removably coupled to one another. In any of the embodiments described herein, the first coupler and the second coupler may fit together via an interference-type fit, wherein removal of the figure from the base creates a “popping” sound, thereby providing a satisfying experience for the user in attaching/detaching various figures as desired. Various embodiments of accessory assemblies will be described in more detail herein.

As used herein, the term “figure” may refer to any figurine, character, statuette, or other object, decorative or otherwise. For example, a figure may be include or embody an image of a cartoon character, animal, person, toy, equipment (e.g., sporting equipment, science equipment, construction equipment, etc.), logo, insignia, food item, or the like. In the depicted embodiments, the figure is illustrated as a rubber duck though any figure may be used.

As used herein, the term “base” may refer to any substrate, article, or structure to which the figure may be removably attached. For example, a base may include a plate, a bag, belt, strap, shoe, clothing, drinkware, box, keychain, suction cup, cooler, insulated container, vehicle, dashboard, etc.

It is noted that directional terms such as above, below, top, bottom, as used herein refer specifically to the arrangement and orientations within the figures and are not intended to be otherwise limiting.

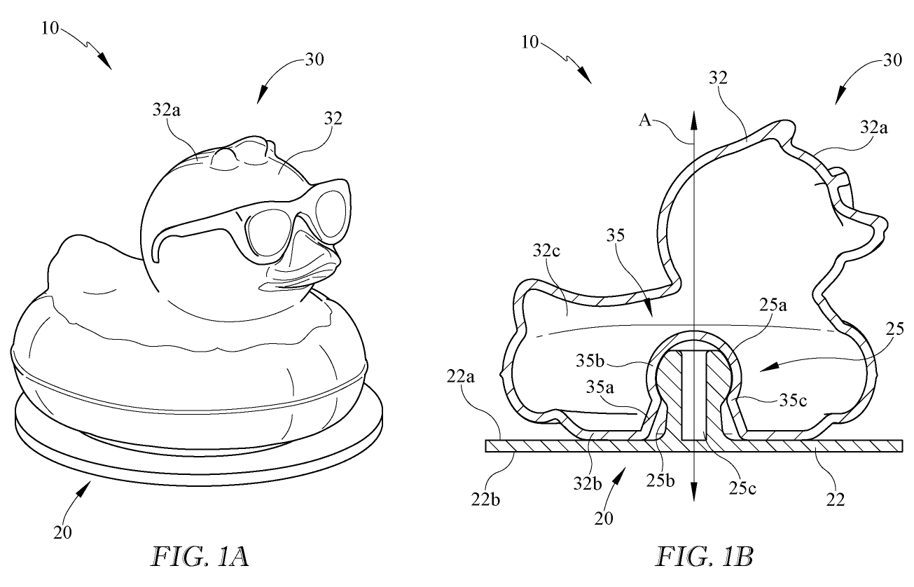

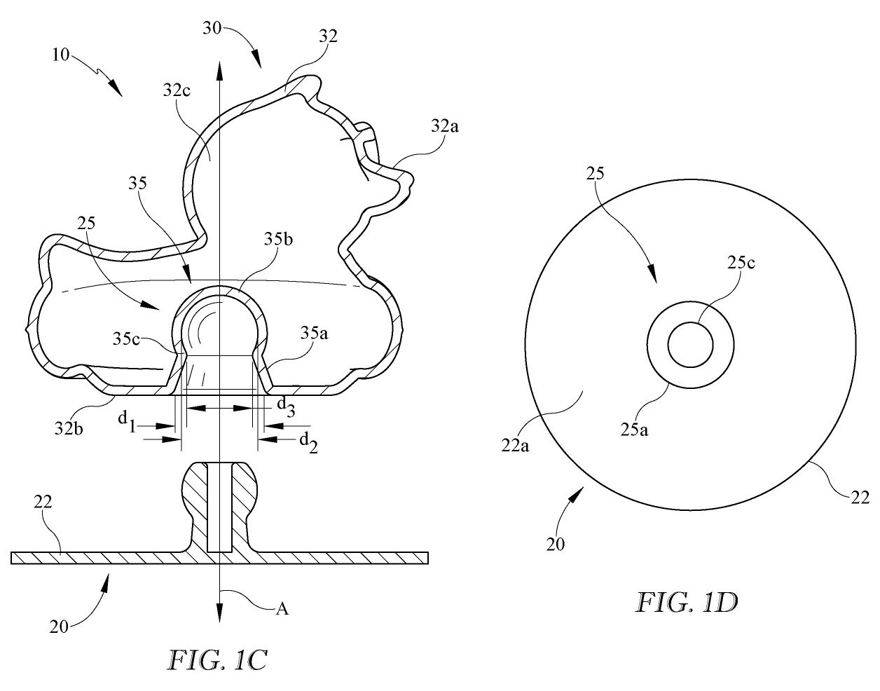

Referring now to FIG. 1A-1D, an accessory assembly 10 is generally depicted. The accessory assembly 10 includes a base 20 and a FIG. 30 removably coupled to the base 20. Removable couplings may take many forms. In embodiments, the base 20 and the FIG. 30 may interlock with one another such as via an interference fit, threaded engagement, or the like. For example, the coupling means may include a male/female coupler arrangement that includes a male coupler 25 and a female coupler 35, wherein the male coupler 25 is removable received within the female coupler 35. Other means of coupling may include, but are not limited to, clips, hook and loop fasteners, snaps, etc.

In the illustrated embodiment, the base 20 may include a substrate 22. The substrate 22 may be any shape, such as round, rectangular, triangular, or any regular or irregular polygonal or nonpolygonal shape. The substrate 22 may further be formed out of any flexible or rigid material including, but not limited to, rubber, fabric, plastic, metal, wood, or the like. The substrate 22 may include a first surface 22a and a second surface 22b opposite the first surface 22a. The first surface 22a may define a flat engagement surface against which the FIG. 30 may be positioned. The substrate 22 may have any suitable thickness and need not be limited to any particular thickness. By way of example, and without limitation, the substrate 22 may be between about 1 mm and about 3 mm thick, such as about 1.8 mm to about 2 mm thick.

Extending from the substrate 22, such as from the first surface 22a may be a coupler, such as male coupler 25. For example, the male coupler 25 may extend from a center of the first surface 22a, such as a radial center of the first surface 22a where the first surface 22a is circular/round. In such embodiments, the first surface 22a may circumscribe the male coupler 25. The male coupler 25 may have any suitable shape for being received within a corresponding female coupler 35. For example, the male coupler 25 may be substantially pin-shaped and include a pin head 25a and a neck 25b. The pin head 25a may be any suitable shape, such a spherical, at least partially dome-shaped, or the like. The neck 25b may include a neck dimeter that is less than a diameter of the pin head 25a. In some embodiments, the male coupler 25 may define a void 25c extending inwardly from an insertion end (e.g., the pin head 25a) toward a base (e.g., where the neck 25b engages the first surface 22a) of the male coupler 25. For example, the void 25c may extend completely through the male coupler 25 to the first surface 22a. In some embodiments, the void 25c may extend through substrate 22. The void 25c may provide flexibility to the male coupler 25, thereby easing insertion into the corresponding female coupler 35. In some embodiments, the void 25c may improve molding, such as where the base 20 or coupler is injection molded, by preventing unwanted shrinkage. However, it is noted that in various embodiments there may not be a void 25c. In yet further embodiments, a void 25c could instead extend through the substrate 22 and terminate prior to (or alternatively extend through) a distal end of the pin head 25a.

It is noted that the base 20 and male coupler 25 may be integral with one another such that they are formed of the same material. In other embodiments, the male coupler 25 may be coupled to the base 20 via any suitable means including, but not limited to adhesive, welding, fastening, sewing, over-molding, etc. In such embodiments, the base 20 and the male coupler 25 may, though not necessarily, be formed of different materials. However, it is desirable that the male coupler 25 have suitable stiffness to substantially maintain its upright configuration during insertion into the female coupler 35. For example, the male coupler 25, may be formed of polypropylene or other rigid material.

As noted above, the FIG. 30 may include any type of figurine, character, statuette, or other object, decorative or otherwise. In the depicted embodiment, the FIG. 30 is depicted as a rubber duck, thought other items are contemplated and possible. The FIG. 30 may generally include a hollow body 32, which may be blow molded, injection molded, rotationally molded, or the like. The hollow body 32 may have any suitable wall thickness and need not be limited to any particular thickness. For example, the hollow body 32 may have a wall thickness between about 1 mm and 2 mm thick, such as about 1.5 mm. The FIG. 30 may be formed of any suitable material such as rubber, plastic, silicone, PVC, TPR, LDPE, or the like. In some embodiments, the material or hollow body 32 may be buoyant. In embodiments, the FIG. 30 may be formed of a single material or combination of materials. In embodiments, the hollow body 32 includes an upper 32a and a base surface 32b (also referred to as an engagement surface) from which the upper 32a extends. The upper 32a may include various contours defining the visible contours of the figure when mounted to the base 20. The upper 32a may include various features, colors, and the like. For example, the upper 32a illustrated includes a float and sunglasses adorning the rubber duck. Other adornments are contemplated and possible including costumes, outfits, etc. Such adornments may be integral with the hollow body 32 or separable therefrom.

The base surface 32b may provide a flat engagement surface for engagement with the first surface 22a of the base 20. When mounted to the base 20, the base surface 32b may engage the first surface 22a along a common boundary (such that both flat engagement surfaces interface with one another). In some embodiments, as opposed to a flat engagement surface, the base surface 32b may include a ridge or similar structure, which may orient or otherwise position the FIG. 30 as desired or in a particular orientation.

The FIG. 30 may include the female coupler 35, which may be positioned, formed, or recessed within the base surface 32b. For example, the female coupler 35 may extend from a center of the base surface 32b into an internal volume 32c of the hollow body 32. The female coupler 35 may define a first portion 35a, a second portion 35b, and a connecting portion 35c between the first portion 35a and the second portion 35b. The various portions may be generally circular about an axis A of the female coupler 35, the axis A defining an insertion/removal direction. For example, FIG. 1C illustrates the base 20 removed from the FIG. 30. In such configuration, it can be seen that the first portion 35a may provide an entry into the female coupler 35. The first portion 35a may have a first maximum diameter d₁. The second portion 35b may be rounded or dome-shaped, and may have a second maximum diameter d₂. The first maximum diameter d₁may be larger than the second maximum diameter d₂. Accordingly, the first maximum diameter d₁ may assist in guiding the male coupler 25, such as the pin head 25a, into the female coupler 35. The connecting portion 35c may be connect the first portion 35a to the second portion 35b and may have a reduced diameter d₃, which is less than both the first maximum diameter d₁ and the second maximum diameter d₂. The reduced diameter d₃ may be less than a diameter of the pin head 25a of the male coupler 25, such that an interference fit exists between the male coupler 25 and the female coupler 35 and assembled to one another. Once assembled, the pin head 25a may be positioned within the second portion 35b, and the neck 25b may extend through the first portion 35a and the connecting portion 35c. To assist in insertion, the first portion 35a may slope, such as linearly slope, from the first maximum diameter d₁to the reduced diameter d₃. In embodiments, the FIG. 30 may be pivotable about the male coupler 25 when coupled thereto via the female coupler 35 so as to be able to rotate to any desired position.

The size difference between the pin head 25a and the connecting portion 35c and/or the interface of the pin head 25a with the second portion 35b may generate a popping noise when coupling or decoupling the FIG. 30 to/from the base 20. In some embodiments, the void 25c may form a suction type connection to a surface of the second portion 35b, which may create the popping noise when decoupling the FIG. 30 from the base 20. The popping noise may be tuned such as by adjusting various dimensions of the couplers, such as, but not limited to, the pin head 25a, the connecting portion 35c, the second portion 35b, and/or the void 25c. Moreover, the popping noise may be tuned via material property. In embodiments, the female coupler 35 may be formed of a softer material than the male coupler. For example, the pliability or rigidity of the material of either the female coupler 35 or the male coupler 25 may cause increased or decreased noise. Moreover, the speed at which a user couples or decouples the character 30 from the base may also lead to an increase or decrease in popping noise. For example, the faster a user decouples the female coupler 35 from the male coupler 35 the louder the popping noise may be.

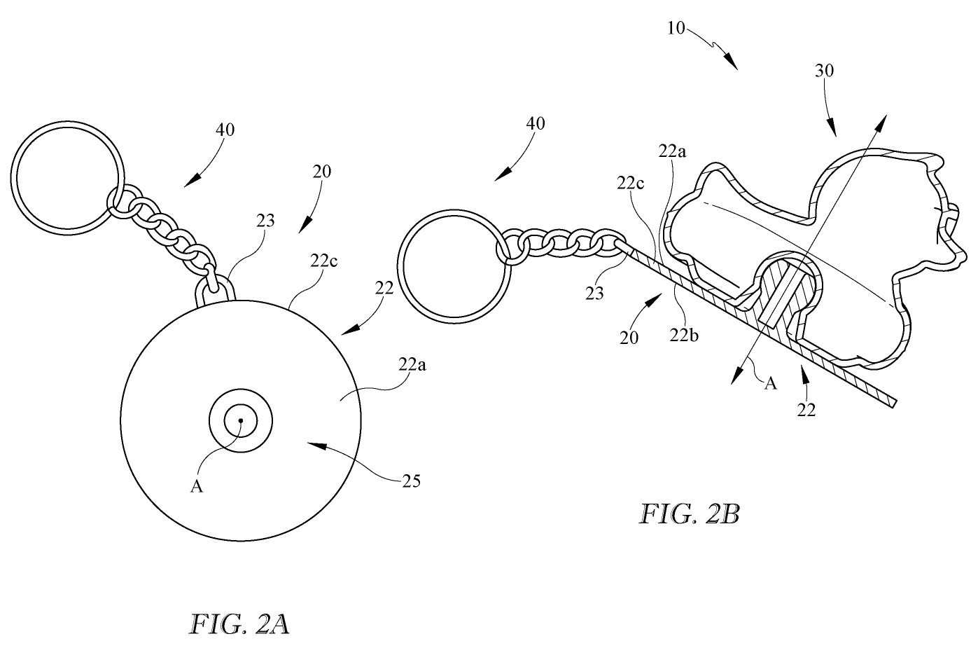

Referring now to FIG. 2A and 2B, the base 20 is configured with a chain 40 (e.g., a keychain), which would allow the accessory assembly 10 to be mounted to user articles (e.g., keys, bags, etc.) via the chain 40. In some embodiments, the base 20 may include a chain mount 23, which may extend from any portion of the base 20, such as at or within an edge 22c, extending between the first surface 22a and the second surface 22b as depicted. For example, the chain mount 23 may include a hole or recess which may receive a link or connector of the chain 40. Chain 40 may be accordingly attached to the chain mount 23. In the depicted embodiment, the chain mount 23 has a similar side profile as the substrate 22. Further in the depicted embodiment the chain mount 23 is offset, such as radially offset from axis A, so as to be spaced from the male coupler 25.

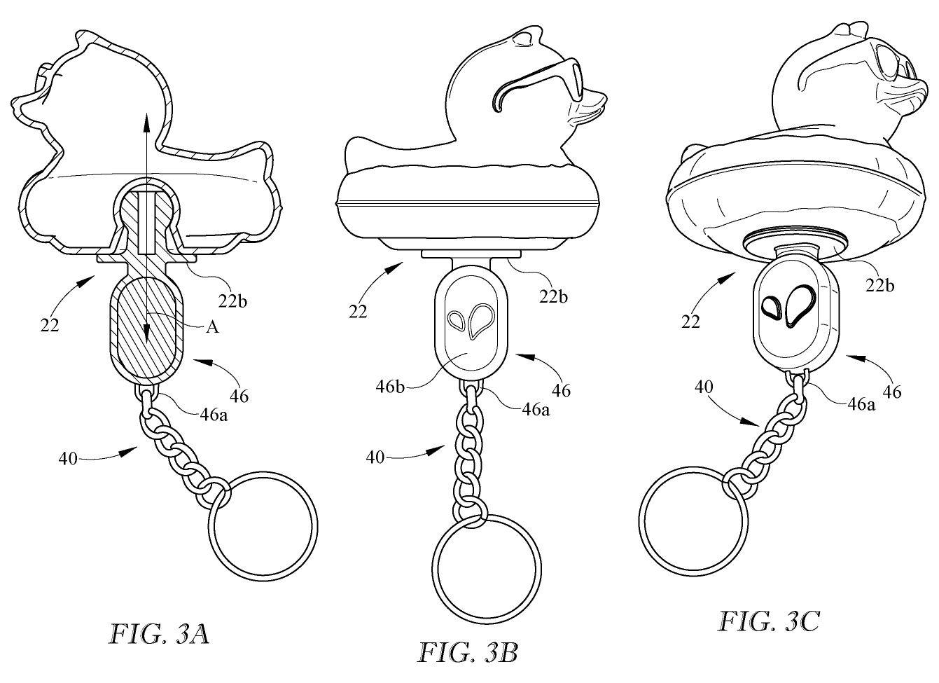

Referring now to FIGS. 3A-3C, an accessory assembly 10 similar to that described above is depicted which is substantially similar unless as otherwise noted or apparent. In particular, in the present embodiment, the base 20 is illustrated with a smaller substrate 22. In particular, the substrate 22 is smaller than the base surface 32b of the FIG. 30. However, a substrate 22 may instead be larger than the base surface 32b as illustrated in embodiments above. Furthermore, in this particular embodiment, extending from the second surface 22b of the substrate 22 is a fob 46. In some embodiments, the fob 46 may include a chain mount 46a, which may extend from any portion of the 406b. For example, the chain mount 46a may extend from the fob 46 opposite the substrate 22. For example, the chain mount 46a may include a hole or recess which may receive a link or connector of the chain 40. Chain 40 may be accordingly attached to the chain mount 46a. Further in the depicted embodiment the fob 36 and, in some embodiments, chain mount 46a is offset may be arranged, such as radially offset, along axis A, so as to be in-line with the male coupler 25 along axis A.

The fob 46 may have any suitable or desired shape. In some embodiments, the fob 46 may have a flat expanse 46b onto which a logo may be positioned, molded, or the like. The fob 46 may be integral with the substrate 22 or coupled thereto via any suitable technique (e.g., fasteners, adhesives, etc.). In some embodiments, the flat expanse 46b, may be part of a removable and/or replaceable insert, such that the fob 46 itself may be personalized is any desired insert.

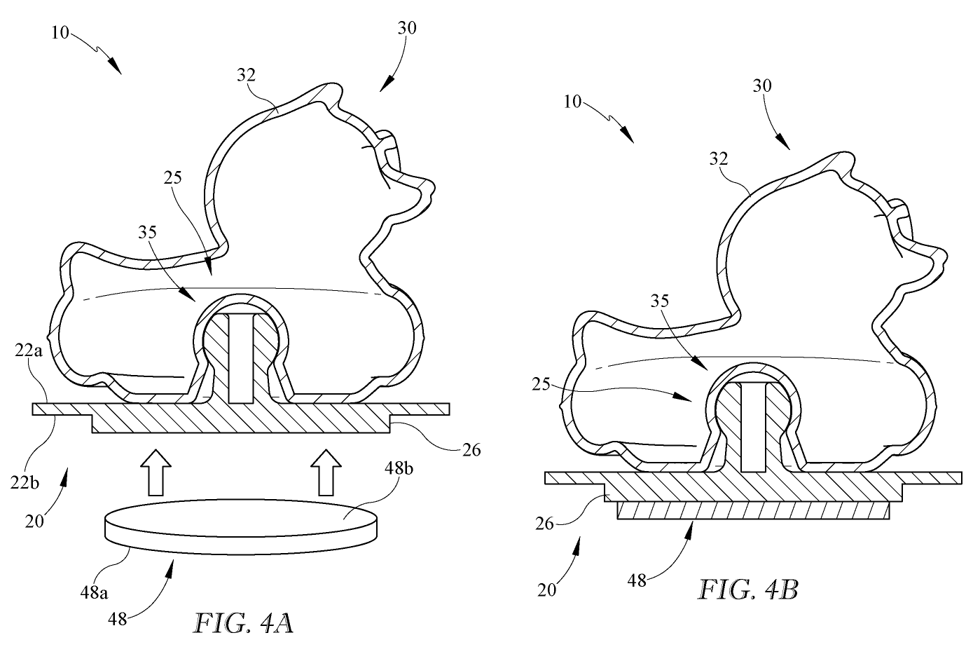

Referring now to FIGS. 4A and 4B, an accessory assembly 10 similar to that described above is with respect to FIGS. 1A-1D is depicted. However, in the present embodiment the base 20 is provided with a platform 26 formed or positioned on the second surface 22b. The platform 26 may provide an area of increased thickness and/or rigidity. In such embodiments, a sticker 48, also referred to as an adhesive substrate, may be positioned on the platform 26. In embodiments, the sticker 48 may be a double sided sticker including a first sticky surface 48a and a second sticky surface 48b opposite from the first sticky surface 48a, such as to stick to the platform 26 and to allow the base 20 to then be attached, via the sticker 48, to any desired article (e.g., dashboard, desk, counter, etc.). In some embodiments, there may not be a platform 26. However, embodiments with a platform 26, may provide for improved adhesion between the sticker 48 and the base 20 as increased stiffness/rigidity may assist in preventing the sticker 48 from inadvertently peeling off.

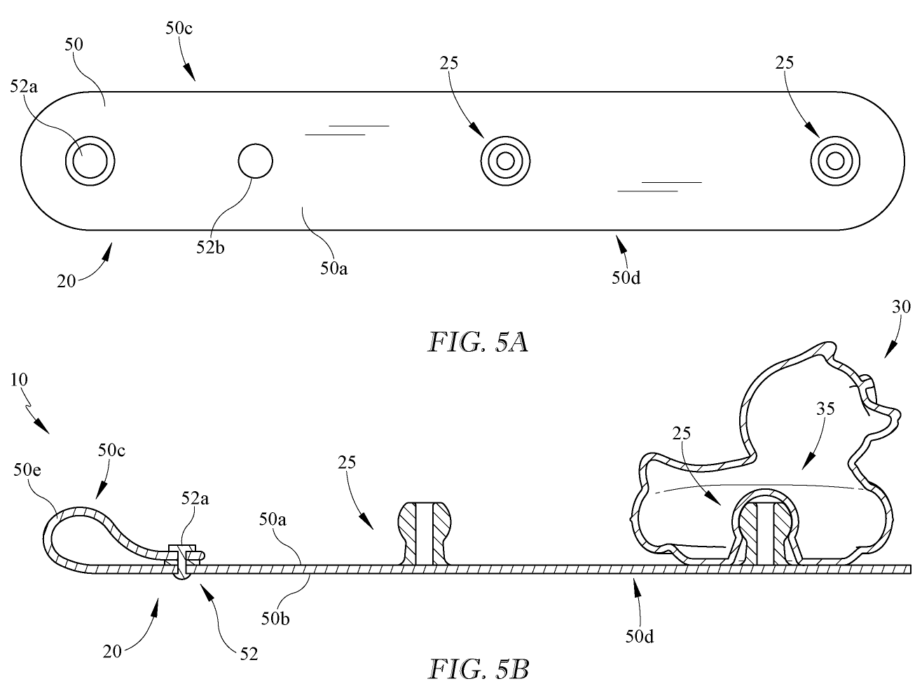

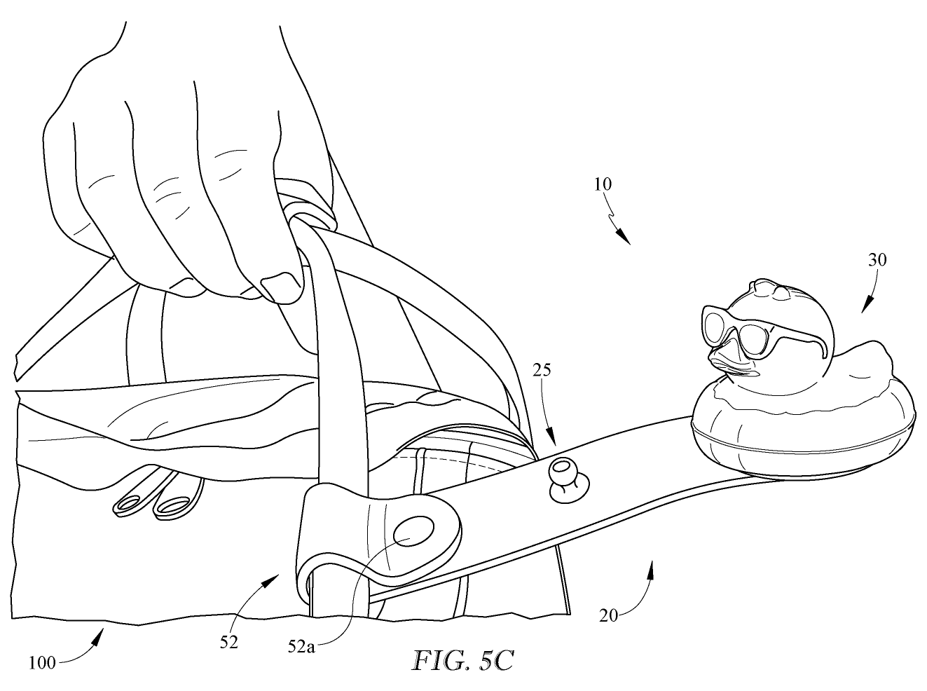

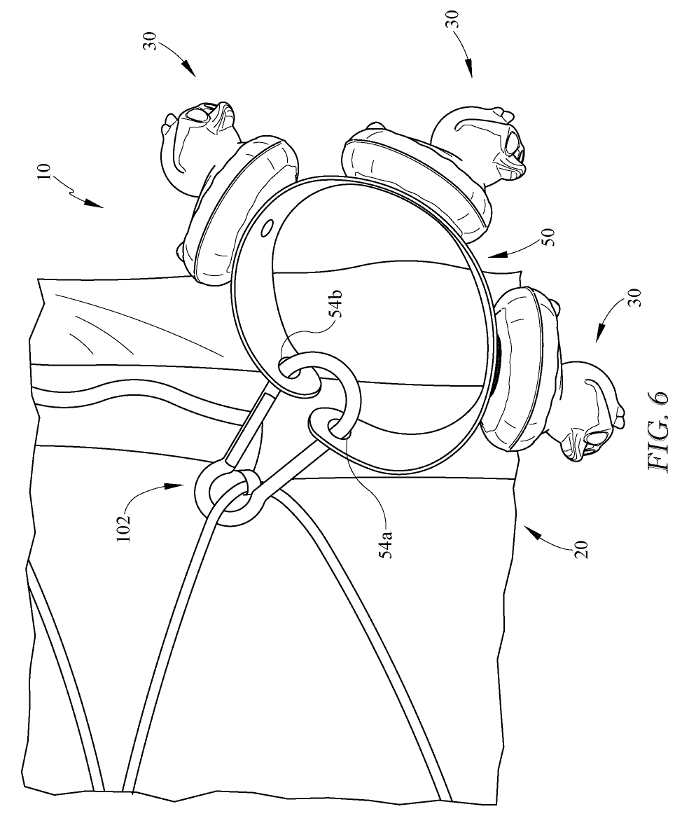

Referring now to FIGS. 5A-5C, a base 20 for use with an accessory assembly 10 is depicted. However, in the depicted embodiment, the base 20 includes a strap 50. The strap 50 may be a flexible length of material (e.g., fabric, leather, plastic, silicone, or the like). The strap 50 may include a male coupler 25 such as described above attached thereto via any suitable techniques, such as noted above. In embodiments, the strap 50 may include a plurality of male couplers 25, attached thereto. For example, while two male couplers 25 are depicted, any number of male couplers 25 may be included such as two or more, four or more, etc. Each male coupler 25 may be spaced from the other any suitable distance to allow room for the equivalent number of FIGS. 30 to attach thereto. The strap 50 may include a first surface 50a and a second surface 50b opposite the first surface 50a. It is noted that while the male couplers 25 are illustrated as extending from the first surface 50a, the male couplers 25 may alternatively extend from the second surface 50b or both the first surface 50a and the second surface 50b.

In some embodiments, the strap 50 may include a first strap portion 50c and a second strap portion 50d. The male coupler(s) 25 may be coupled to the second strap portion 50d. The first strap portion 50c may be formable into a loop 50e. For example, the strap 50, such as the first strap portion 50c, may include closure 52 for forming the loop. The closure 52 may include any suitable closure such as latch, snap, hook and loop, button closure, or the like. For example, in the depicted embodiment, the closure 52 includes a button 52a positioned at an end of the strap 50 and an opening 52b formed within the strap 50. As illustrated particularly in FIG. 5B, the loop 50e may be closed by inserting in the button 52a through the opening 52b. FIG. 5C depicts the loop 50e allowing a user to attach the accessory assembly 10 to a bag 100. Accordingly, the strap 50 may be attached to multiple articles using the loop 50e.

FIG. 6 depicts an accessory assembly 10 including a strap 50, however, instead of loop 50e, the strap 50 includes a first opening 54a at a first end and a second opening 54b at a second end. A plurality of FIGS. 30 may be mounted to the strap 50 as described above between the first opening 54a and the second opening 54b. The openings 54a, 54b may allow the accessory assembly 10 to be mounted to a hook or similar structure, such as a carabiner 102 depicted.

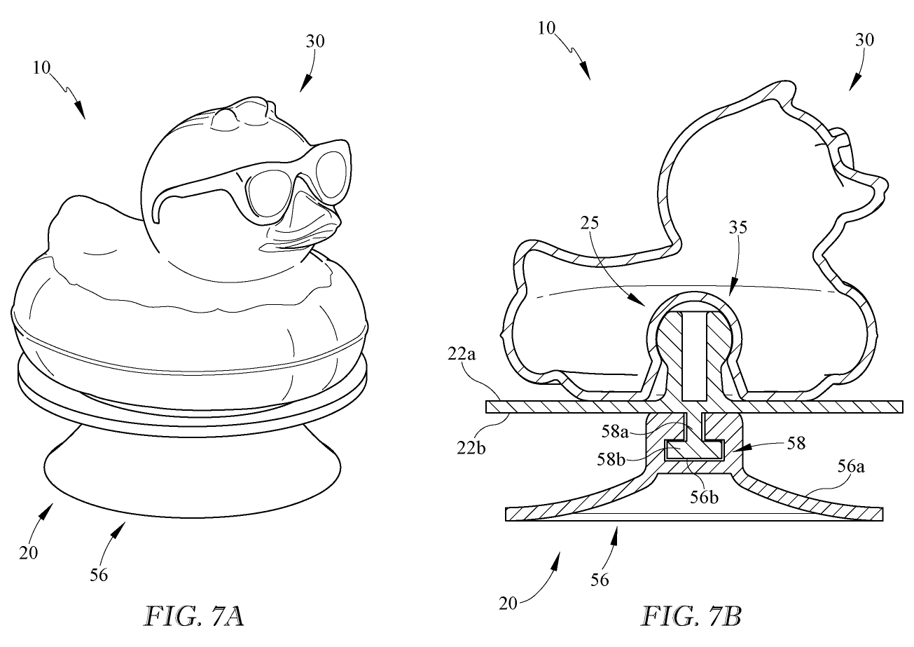

FIGS. 7A and 7B illustrate yet another accessory assembly 10 similar to the accessory assembly 10 described with respect to FIGS. 1A-1D. However, in the present embodiment, a suction cup 56 is coupled to the base 20. The suction cup 56 may be mounted to the base 20, such as the second surface 22b of the base 20 via any suitable means (e.g., fasteners, adhesives, etc.). In the depicted embodiment, suction cup mount 58 is illustrated extending from the second surface 22b of the base 20. The suction cup mount 58 may extend from the second surface 22b at a position aligned with and opposite the male coupler 25, though other positions are contemplated and possible. The suction cup mount 58 may include a base extension 58a and a plate 58b coupled to the base extension 58a. The plate 58b may have a width greater than the base extension 58a and may be sized to be received with a mating recess 56b of a body 56a of the suction cup 56. Accordingly the body 56a may envelope around the plate 58b to hold the suction cup 56 to the base 20. Accordingly, with the suction cup 56, the accessory assembly 10 may be removably mounted to various solid surfaces (e.g., windows, mirrors, etc.). As depicted the suction cup 56 may be aligned with the male coupler 25, but need not be.

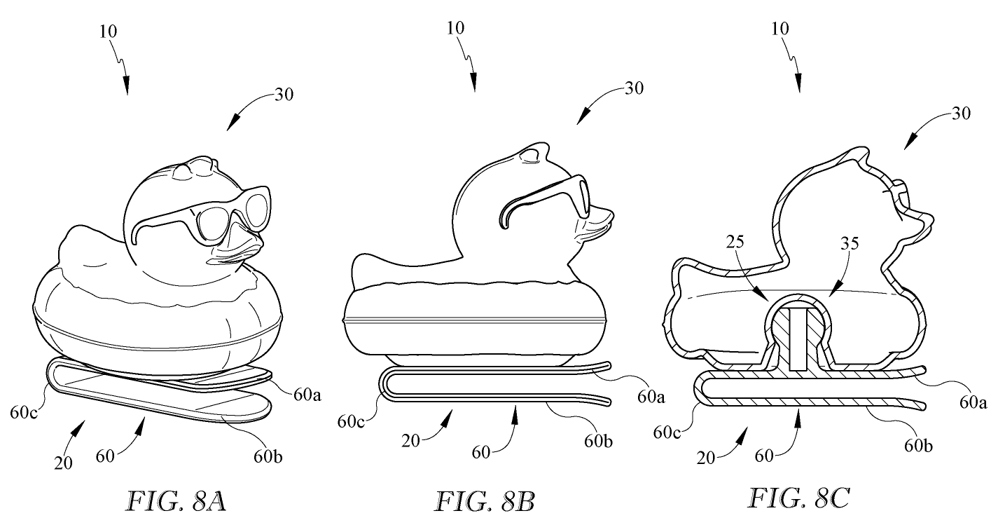

FIGS. 8A-8C illustrate yet another accessory assembly 10 similar to the accessory assemblies described above. However, in the present embodiment, the base 20 is a clip 60. 10 described with respect to FIGS. 1A-1D. The clip 60 may include a first substrate 60a and a second substrate 60b spaced, e.g., vertically spaced in the figure, from the first substrate 60a. A connector 60c connects the first substrate 60a and the second substrate 60b. The clip 60 may be formed of a spring material (e.g., metal, plastic, etc.), which causes the first substrate 60a and the second substrate 60b, via the connector 60c, to return to a neutral position such as shown when opened further away from one another and/or compressed toward one another. Accordingly, the clip 60 may allow the accessory assembly 10 to resiliently clip onto various articles (e.g., binders, books, closing, hair, etc.). In the illustrated embodiment, the male coupler 25 extends from the first substrate 60a, but could extend from the second substrate 60b, the connector 60c, or any portion of the clip 60. In embodiments, multiple male couplers 25 may extend from any portion of the clip 60.

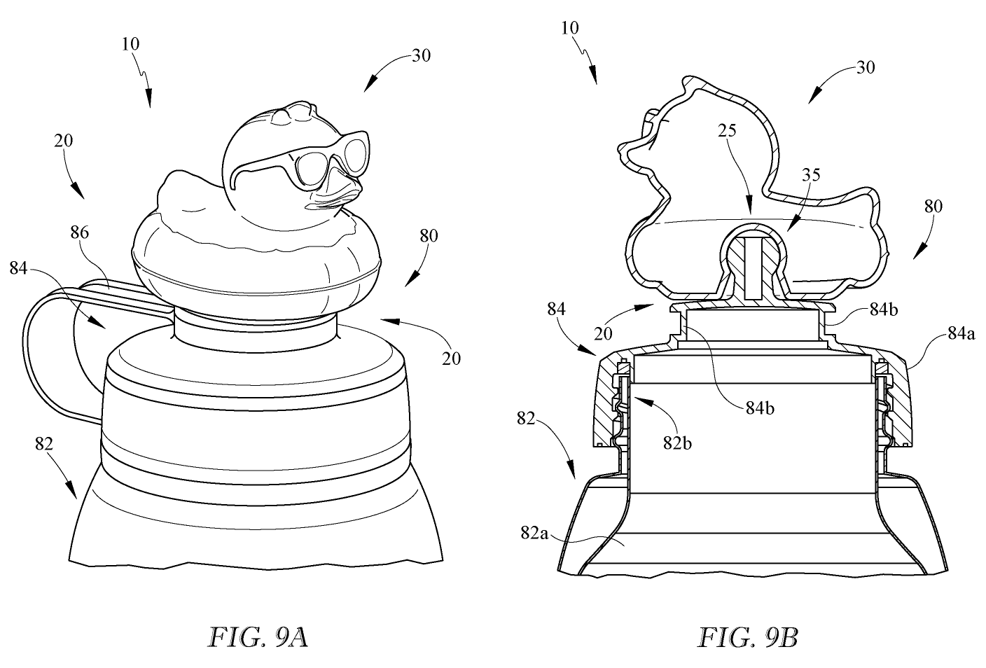

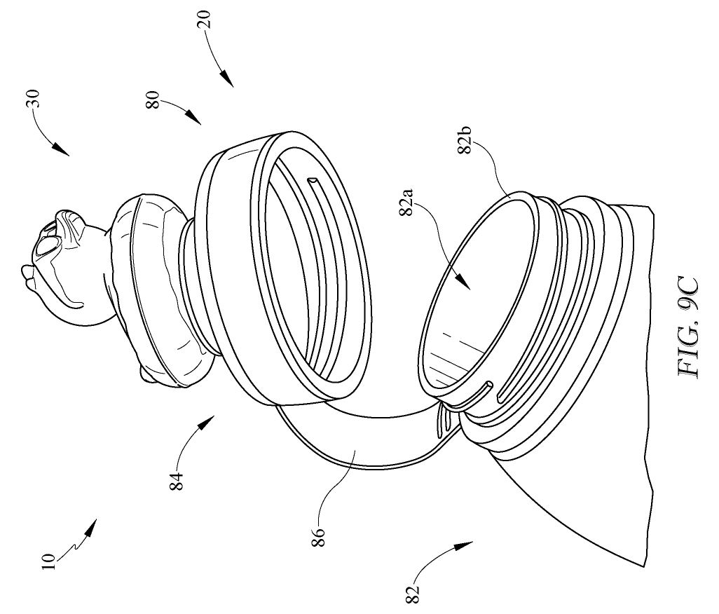

Referring now to FIGS. 9A-9C, the accessory assembly 10 is incorporated with a drinkware 80. The drinkware 80 may be any type of vessel, such as a single walled cup, double walled tumbler, bottle, etc. Further the drinkware 80 may be formed of any suitable material including plastic, aluminum, stainless steel, etc. For example, the drinkware 80 includes a vessel body 82 defining an interior volume 82a and an opening 82b into the interior volume 82a. A closure 84 (e.g., a lid), may be coupled to the vessel body 82 and extends over the opening 82b to enclose the interior volume 82a. The closure 84 may take on many forms. In embodiments, at least a portion of the closure 84 is actuatable or removable to provide a flow path from the interior volume 82a. For example, in the depicted embodiment, the closure 84 is removable. The closure 84 may include a tether 86 which ensures that the closure 84 remains attached to the vessel body 82 when removed from about the opening 82b. In some embodiments, the closure 84 may be only partially removable.

The FIG. 30 is attached to the drinkware 80 such as the vessel body 82 or the closure 84. In some embodiments, the FIG. 30 is attached to a removable portion of the closure 84. In the present embodiment, the figure is attached to the closure 84. For example, the base 20 may be incorporated into the closure 84 for removably mounting the FIG. 30 thereto. For example, the base 20 may be integral with the closure 84 or otherwise coupled thereto (e.g., fasteners, adhesives, or the like). The closure 84 may include a vessel-receiving portion 84a which is sized and shaped to receive the vessel body 82 about the opening 82b. For example, the vessel-receiving portion 84a may receive the vessel body 82 about the opening 82b and couple thereto via press fit, threaded engagement, or the like. The base 20 may be coupled to the vessel-receiving portion 84a, and may be elevated therefrom such as via a column 84b. The column 84b may provide a recess within which a portion of the tether 86 may be received. The male coupler 25 may extend from the base 20, such as the substrate 22 for receiving the FIG. 30. In the present embodiment, the FIG. 30 may be firmly secured to the male coupler 25 such as to be undisturbed when opening and closing the closure 84.

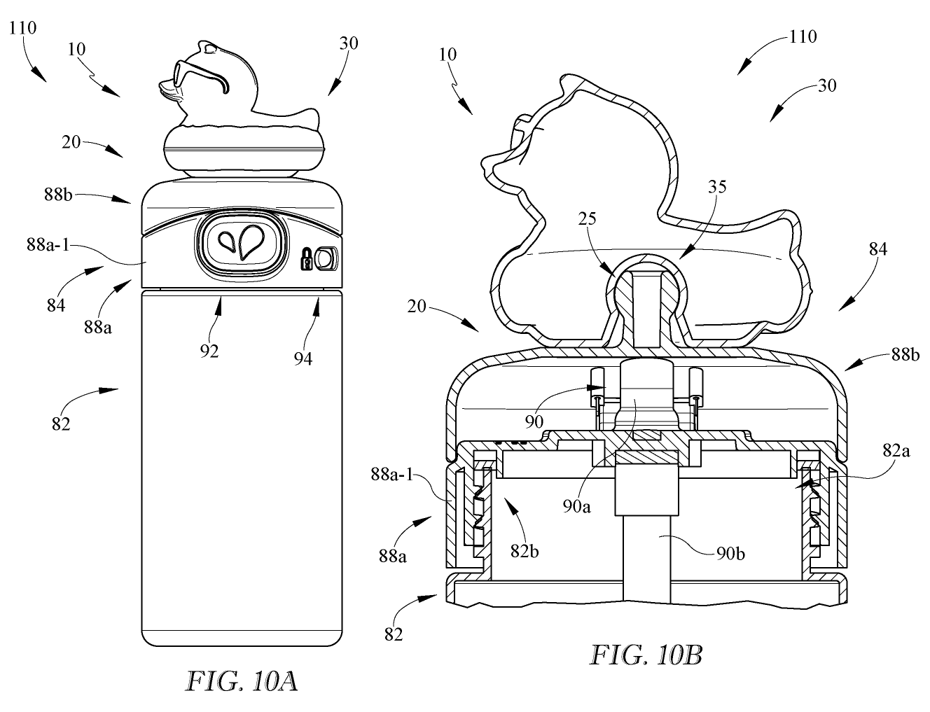

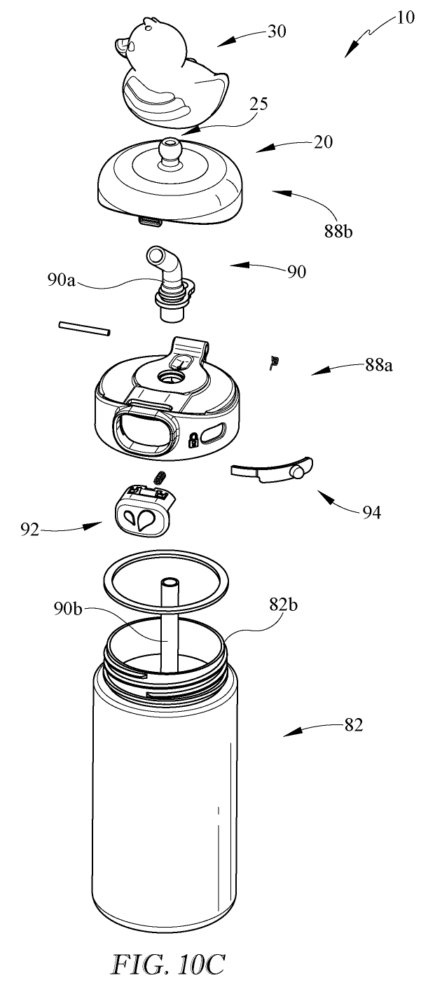

FIG. 10A-10C depicts the accessory assembly 10 incorporated within another drinkware 110, as in the embodiment above, the drinkware includes a closure 84 and a vessel body 82. However, in the present embodiment, the closure 84 includes a base lid 88a, a top lid 88b, and a straw 90. In particular, the base lid 88a may be include a vessel-receiving portion 88a-1 which is sized and shaped to receive the vessel body 82 about the opening 82b. For example, the vessel-receiving portion 88a-1 may receive the vessel body 82 about the opening 82b and couple thereto via press fit, threaded engagement, or the like. The top lid 88b may be pivotally coupled to the base lid 88a, such as via a hinge arrangement between the top lid 88b and the base lid 88a.

The straw 90 may extend through the base lid 88a. As illustrated in FIG. 10c the straw 90 may include a first straw portion 90a which extends above the base lid 88a and a second straw portion 90b which extends below the base lid 88a into the interior volume 82a. In such embodiments, the first straw portion 90a may be formed of a more flexible material than the second straw portion 90b to allow easy bending of the first straw portion 90a beneath the top lid 88b. As noted above, the top lid 88b may be hingedly coupled the base lid 88a. When closed, the top lid 88b may bend the first straw portion 90a, which may seal off a flow path through the straw 90. In embodiments, the closure 84 may include an actuator 92, such as a button, which may release the top lid 88b from the closed position (such as by releasing a latch holding the top lid 88b closed relative to the base lid 88a). In some embodiments, the top lid 88b may be spring biased to an open configuration such that when the actuator 92 is actuated, the top lid 88b springs open. In some embodiments, a locking mechanism 94 (e.g., a sliding lock) may be used to selectively prevent actuation of the actuator 92. In some embodiments, there may not be an actuator, and the lid be manually pulled open and held closed via a latch, for example.

In the depicted embodiment, the FIG. 30 is attached to the top lid 88b. For example, the base 20 is incorporated into the top lid 88b, and may be integral therewith. Accordingly, the male coupler 25 may extend vertically, such as centrally, from the top lid 88b and removably receive the FIG. 30. In some embodiments, the character 30 may be arranged over at least a portion of the straw 90, such as the first straw portion 90a, of the straw 90 when the top lid 88b is arranged in a closed position. In some embodiments, that male coupler 25 may be arranged over at least a portion of the straw 90, such as the first straw portion 90a, of the straw 90 when the top lid 88b is arranged in a closed position.

It is noted that in embodiments above, the FIG. 30 is depicted centrally on the drinkware 80, 110, but need not be. For example, the FIG. 30 could be positioned off center. In some embodiments, the straw 90 may extend through the closure so as to pass next to or adjacent the FIG. 30.

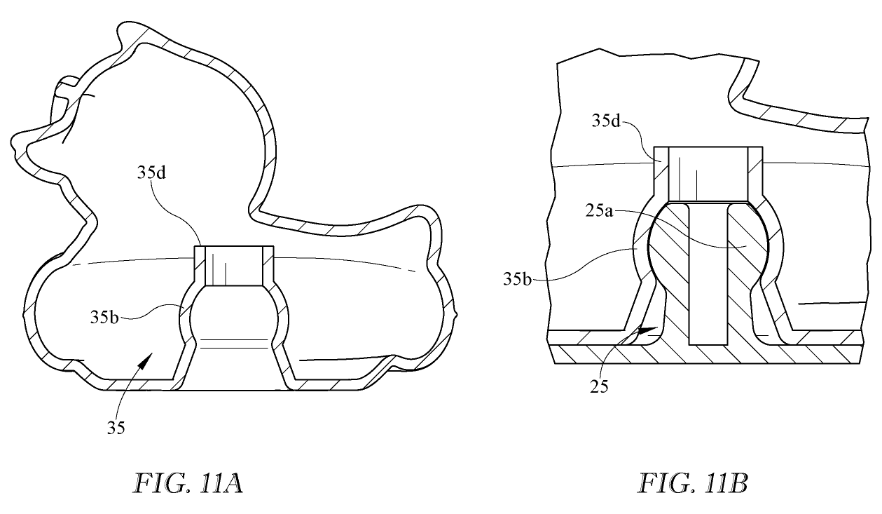

Referring now to FIG. 11A and 11B a FIG. 30 is depicted wherein the female coupler 30 has an open internal end 35d. In some embodiments, the second portion 35b is only partially dome-shaped, though other shapes are contemplated and possible, and the open internal end 35d extends, such as vertically extends, from the second portion 35b. In embodiments, instead of extending, the open internal end 35d, may just be an opening directly into the second portion 35b. Accordingly, the open internal end 35d may be a passage between an internal volume of the female coupler 30 to the internal volume 32c of the FIG. 30. Having an open internal end 35d may aid in manufacturing such as disengagement from a mold. FIG. 11B illustrated the female coupler 35 coupled to the male coupler 25. The pin head 25a, may be substantially flat or planar at a distal end. In embodiments, the open internal end 35b may begin at a position substantially aligned with an outer edge of the flat portion of the distal end of the pin head 25a. The female coupler of FIGS. 11A and 11B may be incorporated into any of the accessory assemblies 10 described herein.

Further in various embodiments described herein, while the female coupler 35 is illustrated as attached to the FIG. 30 and the male coupler 25 is illustrated at attached to the base 20, this is not limiting, and the couplers may be switched. For example, the female coupler 35 may be integrated into the base 20 which the male coupler 25 is integrated into the FIG. 30.

The following numbered clauses further described various embodiments:
1. An accessory assembly comprising: a base defining a first coupler; and a figure defining a second coupler, wherein the base and the figure are removably coupled to one another via the first coupler and the second coupler.
2. The accessory assembly of clause 1, wherein the base comprises one of a strap, a belt, a keychain, a suction cup, or a lid.
3. The accessory assembly of any preceding clause, the figure and the base couple to one another via a male/female coupler arrangement comprising a female coupler and a male coupler, and the male coupler is removably received within the female coupler.
4. The accessory assembly of clause 3 wherein: the figure comprises the female coupler; and the base comprise the male coupler.
5. The accessory assembly of clause 3 or 4, wherein: the figure comprises first flat engagement surface; the base comprises a second flat engagement surface; and the first flat engagement surface and the second flat engagement surface engage with one another when the figure is removably attached to the base.
6. The accessory assembly of any of clauses 3-5, wherein: the female coupler comprises a first portion and a second portion; the first portion has a first maximum diameter; the second portion has a second maximum diameter; and a connecting portion between the first portion and the second portion and a reduced diameter which is less that the first maximum diameter and the second maximum diameter.
7. The accessory assembly of clause 6, wherein the first portion slopes linearly from the first maximum diameter to the reduced diameter.
8. The accessory assembly of any of clauses 3-7, wherein the female coupler is at least partially dome-shaped.
9. The accessory assembly of any of clauses 3-8, wherein the male coupler is pin shaped comprising a pin head and a neck, wherein a neck diameter is less that a pin head diameter.
10. The accessory assembly of any of clauses 3-9, wherein the male coupler defines a void extending inwardly from an insertion end toward a base of the male coupler.
11. A drinkware assembly, comprising: a drinkware comprising: a vessel body defining an interior volume and an opening into the interior volume; and a closure coupled to the vessel body and extending over the opening, at least a portion of the closure being actuatable or removable to provide a flow path from the interior volume; and a figure removably attached to the drinkware.
12. The drinkware assembly of clause 11, wherein the figure and the drinkware couple to one another via a male/female coupler arrangement comprising a female coupler and a male coupler, and the male coupler is removably received within the female coupler.
13. The drinkware assembly of clause 12 wherein: the figure comprises the female coupler; and the drinkware comprise the male coupler.
14. The drinkware assembly of clause 12 or 13, wherein: the figure comprises first flat engagement surface; the drinkware comprises a second flat engagement surface; and the first flat engagement surface and the second flat engagement surface engage with one another when the figure is removably attached to the drinkware.
15. The drinkware assembly of any of clauses 12-14, wherein: the female coupler comprises a first portion and a second portion; the first portion has a first maximum diameter; the second portion has a second maximum diameter; and a connecting portion between the first portion and the second portion and a reduced diameter which is less that the first maximum diameter and the second maximum diameter.
16. The drinkware assembly of clause 15, wherein the first portion slopes linearly from the first maximum diameter to the reduced diameter.
17. The drinkware assembly of any of clauses 12-16, wherein the female coupler is at least partially dome-shaped.
18. The drinkware assembly of any of clauses 12-17, wherein the male coupler is pin shaped comprising a pin head and a neck, wherein a neck diameter is less that a pin head diameter.
19. The drinkware assembly of any of clauses 12-18, wherein the male coupler defines a void extending inwardly from an insertion end toward a base of the male coupler. 20. The drinkware assembly of any of clauses 12-19, wherein figure is removably attached to the closure.

It is noted that the terms "substantially" and "about" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An accessory assembly comprising:
a base defining a first coupler; and
a figure defining a second coupler, wherein the base and the figure are removably coupled to one another via the first coupler and the second coupler.

2. The accessory assembly of claim 1, wherein the base comprises one of a strap, a belt, a keychain, a suction cup, or a lid.

3. The accessory assembly of claim 1, the figure and the base couple to one another via a male/female coupler arrangement comprising a female coupler and a male coupler, and the male coupler is removably received within the female coupler.

4. The accessory assembly of claim 3 wherein:
the figure comprises the female coupler; and
the base comprise the male coupler.

5. The accessory assembly of claim 3, wherein:
the figure comprises first flat engagement surface;
the base comprises a second flat engagement surface; and
the first flat engagement surface and the second flat engagement surface engage with one another when the figure is removably attached to the base.

6. The accessory assembly of claim 3, wherein:
the female coupler comprises a first portion and a second portion;
the first portion has a first maximum diameter;
the second portion has a second maximum diameter; and
a connecting portion between the first portion and the second portion and a reduced diameter which is less that the first maximum diameter and the second maximum diameter.

7. The accessory assembly of claim 6, wherein the first portion slopes linearly from the first maximum diameter to the reduced diameter.

8. The accessory assembly of claim 3, wherein the female coupler is at least partially dome-shaped.

9. The accessory assembly of claim 3, wherein the male coupler is pin shaped comprising a pin head and a neck, wherein a neck diameter is less that a pin head diameter.

10. The accessory assembly of claim 3, wherein the male coupler defines a void extending inwardly from an insertion end toward a base of the male coupler.

11. A drinkware assembly, comprising:
a drinkware comprising:
a vessel body defining an interior volume and an opening into the interior volume; and
a closure coupled to the vessel body and extending over the opening, at least a portion of the closure being actuatable or removable to provide a flow path from the interior volume; and
a figure removably attached to the drinkware.

12. The drinkware assembly of claim 11, wherein the figure and the drinkware couple to one another via a male/female coupler arrangement comprising a female coupler and a male coupler, and the male coupler is removably received within the female coupler.

13. The drinkware assembly of claim 12 wherein:
the figure comprises the female coupler; and
the drinkware comprise the male coupler.

14. The drinkware assembly of claim 12, wherein:
the figure comprises first flat engagement surface;
the drinkware comprises a second flat engagement surface; and
the first flat engagement surface and the second flat engagement surface engage with one another when the figure is removably attached to the drinkware.

15. The drinkware assembly of claim 12, wherein:
the female coupler comprises a first portion and a second portion;
the first portion has a first maximum diameter;
the second portion has a second maximum diameter; and
a connecting portion between the first portion and the second portion and a reduced diameter which is less that the first maximum diameter and the second maximum diameter.

16. The drinkware assembly of claim 15, wherein the first portion slopes linearly from the first maximum diameter to the reduced diameter.

17. The drinkware assembly of claim 12, wherein the female coupler is at least partially dome-shaped.

18. The drinkware assembly of claim 12, wherein the male coupler is pin shaped comprising a pin head and a neck, wherein a neck diameter is less that a pin head diameter.

19. The drinkware assembly of claim 12, wherein the male coupler defines a void extending inwardly from an insertion end toward a base of the male coupler.

20. The drinkware assembly of claim 11, wherein figure is removably attached to the closure.
